(19) United States
(12) Patent Application Publication
(10) Pub. No.: US 2025/0218754 A1
(43) Pub. Date: Jul. 3, 2025

(54) MASS SPECTROMETER HAVING HIGH DUTY CYCLE

(71) Applicant: Micromass UK Limited, Wilmslow (GB)

(72) Inventors: Jason Wildgoose, Stockport (GB); Martin Green, Bowdon (GB)

(73) Assignee: Micromass UK Limited, Wilmslow (GB)

(21) Appl. No.: 18/850,020

(22) PCT Filed: Mar. 20, 2023
(86) PCT No.: PCT/GB2023/050680

§ 371 Date: Sep. 23, 2024

(30) Foreign Application Priority Data
Mar. 23, 2022 (GB) 2204106.5

(51) Int. Cl. H01J 49/00; G01N 27/623; H01J 49/02; H01J 49/40; H01J 49/42

(52) U.S. Cl. CPC H01J 49/0031; G01N 27/623; H01J 49/0045; H01J 49/022; H01J 49/40; H01J 49/427

(57) ABSTRACT

A method of mass spectrometry comprising: a) accumulating precursor ions in a first ion accumulator; b) performing a separation cycle comprising pulsing a packet of the precursor ions out of the first ion accumulator and into an ion separator, and separating the precursor ions such that precursor ions having different values of a first physicochemical property elute from the ion separator at different times; c) mass filtering the precursor ions that elute from the ion separator so as to transmit a selected precursor ion species; d) fragmenting or reacting the selected precursor ion species so as to generate a set of fragment or product ion species therefrom; e) accumulating the set of fragment or product ion species in a second ion accumulator; f) releasing the set of fragment or product ion species from the second ion accumulator into a TOP mass analyser, wherein operation of the TOP mass analyser is synchronised with the release of ions from the second ion accumulator such that multiple different species of the set of fragment or product ion species are simultaneously pulsed into a time of flight region of the TOP mass analyser by a pusher electrode; and g) repeating steps c) to f) at least once during said separation cycle, wherein said selected precursor ion species is different each time steps c) to f) are performed.

### CROSS-REFERENCE TO RELATED APPLICATION

This application claims priority from and the benefit of United Kingdom patent application No. 2204106.5 filed on 23 Mar. 2022. The entire content of this application is incorporated herein by reference.

### FIELD OF THE INVENTION

The present invention relates generally to mass spectrometers that pulse ions into a separation region so as to cause the ions to separate according to mass to charge ratio.

### BACKGROUND

In both Data Dependent Acquisition (DDA) and tandem (MSMS) mass spectrometry, precursor ions are filtered such that only a selected species of precursor ion is transmitted downstream for analysis at any given time. The mass spectrometer then selects a different species of precursor ion to be transmitted downstream for analysis. This process continues until the desired species of precursor ions have been analysed. It is generally desirable to sequentially select and transmit as many precursor ions per unit time as possible, in order to analyse the sample as fast as possible. However, on conventional instruments, such as quadrupole-Time of Flight (QToF) mass spectrometers, simply speeding up the rate at which precursor species are selected results in a linear drop in sensitivity for the ions that are detected. For example, if the spectrometer settings are changed such that the number of precursor species that are transmitted increases from 25 different precursors per second to 50 different precursors per second then this leads to half the number of ions in each fragment ion scan.

It is desired to increase the overall duty cycle of such instruments.

### SUMMARY

A first aspect of the present disclosure provides a method of mass spectrometry comprising:
a) accumulating precursor ions in a first ion accumulator;
b) performing a separation cycle comprising pulsing a packet of the precursor ions out of the first ion accumulator and into an ion separator, and separating the precursor ions such that precursor ions having different values of a first physicochemical property elute from the ion separator at different times;
c) mass filtering the precursor ions that elute from the ion separator so as to transmit a selected precursor ion species;
d) fragmenting or reacting the selected precursor ion species so as to generate a set of fragment or product ion species therefrom;
e) accumulating the set of fragment or product ion species in a second ion accumulator;
f) releasing the set of fragment or product ion species from the second ion accumulator into a TOF mass analyser, wherein operation of the TOF mass analyser is synchronised with the release of ions from the second ion accumulator such that multiple different species of the set of fragment or product ion species are simultaneously pulsed into a time of flight region of the TOF mass analyser by a pusher electrode; and
g) repeating steps c) to f) at least once during said separation cycle, wherein said selected precursor ion species is different each time steps c) to f) are performed.

The inventors have recognised that the timescale over which the second ion accumulator is able to accumulate fragment or product ions, and release them for analysis in the TOF mass analyser, is comparable with the timescale over which any given precursor ion elutes from the upstream separator. As such, fragment or product ion species derived from a first precursor ion species that elutes from the ion separator during a given separation cycle of the ion separator are able to be accumulated, trapped and released to the TOF mass analyser before a second precursor ion species elutes from the ion separator within the same separation cycle of the ion separator. The method provides a relatively high duty cycle since a selected precursor ion species is fragmented whilst other precursor ion species remain delayed in the ion separator, rather than those other precursor ion species being discarded. Also, the duty cycle is relatively high because the synchronisation between the second ion accumulator and the TOF mass analyser enables multiple fragment or product ion species of the selected precursor to be analysed simultaneously.

The ion separator may be an ion mobility separator and the physicochemical property may be ion mobility.

For example, the ion separator may be an ion mobility separator configured to drive ions through a background gas arranged therein. The ions may be driven through the background gas by an electric field in order that they separate according to mobility. For example, the ions may be driven by applying a static DC potential gradient along the ion separator and/or by repeatedly travelling a DC potential along the ion separator. The electric field may be arranged so as to urge the ions in a downstream direction (towards the TOF mass analyser) through the ion separator. Alternatively, the background gas may be flowed in the downstream direction and the electric field may be arranged to urge the ions in an upstream direction against the gas flow so as to cause the ions to separate according to mobility.

Other embodiments are contemplated in which the ion separator is a Field Asymmetric Ion Mobility Separator (FAIMS) device or a Differential Mobility Separator (DMS). Less preferably, the ion separator mass be a mass to charge ratio separator and the physicochemical property may be mass to charge ratio.

Each time step c) is performed, only the selected precursor ion species may be transmitted and no other precursor ion species may be transmitted.

Alternatively, each time that step c) is performed, the mass filter may transmit precursor ions having a restricted range of mass to charge ratios, such that multiple precursor ion species are transmitted simultaneously, whereas precursor ions having mass to charge ratios outside of this restricted range are filtered out. Step d) may then comprise simultaneously fragmenting or reacting the multiple precursor ion species transmitted so as to generate multiple respective sets of fragment or product ion species therefrom. Step e) may comprise simultaneously accumulating the sets of fragment or product ion species in the second ion accumulator. Step f) may comprise simultaneously releasing the sets of fragment or product ion species from the second ion accumulator into the TOF mass analyser, wherein operation of the TOF mass analyser is synchronised with the release of ions from the second ion accumulator such that multiple different species of the sets of fragment or product ion species are simultaneously pulsed into a time of flight region of the TOF mass analyser by a pusher electrode. Step g) may comprise repeating steps c) to f) at least once during the separation cycle, wherein said range of mass to charge ratios that is transmitted by the mass filter is different each time steps c) to f) are performed.

Voltages are applied to electrodes of the mass filter so that it transmits a restricted range of mass to charge ratios, such as only a single precursor ion species or multiple precursor ion species, at any given time. According to step g) above, the voltages are varied with time during the separation cycle such that at least one different precursor ion species is transmitted by the mass filter each time that steps c) to f) are performed.

The mass filter may be, for example, a quadrupole mass filter such as a quadrupole rod set mass filter or an axially segmented quadrupole rod set mass filter. However, it is contemplated that other types of mass filters may be used in the present disclosure.

The fragment or product ion species may be urged into the second ion accumulator such that: (i) fragment or product ion species that are derived from the same precursor ion species arrive at the second ion accumulator over substantially the same time period and are accumulated in the second ion accumulator during at least part of this time period; and/or (ii) fragment or product ion species that are derived from precursor species that are transmitted by the mass filter at different times arrive at the second ion accumulator over different respective time periods.

Each time the sequence of steps c) to e) is performed, fragment or product ion species may be accumulated in the second ion accumulator over a time period that is the same as, or correlated to, the time period during which their precursor ion species is transmitted by the mass filter.

For example, fragment or product ion species may be accumulated in the second ion accumulator over a time period that is substantially the same as, or correlated to, the duration between a start time at which a voltage applied to the mass filter is switched so as to begin transmitting the precursor ion species and an end time at which a voltage is applied to the mass filter so as to end transmitting the precursor ions species.

The second ion accumulator may therefore be synchronised with the mass filter such that substantially all fragment or product ions derived from any given precursor ion species are accumulated in the second ion accumulator. This, along with the manner in which the second ion accumulator and TOF mass analyser are synchronised, enables the duty cycle of the spectrometer to be relatively high.

It is also contemplated that each time the sequence of steps c) to e) is performed, fragment or product ion species may be accumulated in the second ion accumulator (only) over a time period that is shorter than the time period during which their precursor ion species is transmitted by the mass filter. For example, fragment or product ion species may be accumulated in the second ion accumulator over a time period that is shorter than the duration between a start time at which a voltage applied to the mass filter is switched so as to begin transmitting the precursor ion species and an end time at which a voltage is applied to the mass filter so as to end transmitting the precursor ions species.

Optionally, each time the sequence of steps c) to e) is performed, only fragment or product ion species derived from the selected precursor ion species, and optionally some ions of the selected precursor ion species itself, are accumulated in the second ion accumulator; whereas other precursor ions species and fragment or product ions derived therefrom are not accumulated in the second ion accumulator.

Accordingly, embodiments of the present disclosure do not simply trap fragment or product ions and release them to the TOF mass analyser, in order to improve duty cycle. Rather, the timescale over which the fragment or product ions are accumulated is set to match the timescale over which their precursor ion species is transmitted by the mass filter. The timescale over which the precursor ion species is transmitted by the mass filter may in turn be set to match the timescale over which the precursor ion species elutes from the separator. As such, embodiments of the present disclosure provide a very high duty cycle. Accordingly, each time the sequence of steps b) and c) is performed, the mass filter may be controlled so as to transmit the precursor ion species of interest only over a time period that is the same as, correlated to, or shorter than the time period during which that precursor ion species elutes from the ion separator.

For example, the mass filter may be controlled so as to transmit the precursor species of interest over a time period that is substantially the same as, correlated to, or shorter than the duration between a start time at which the precursor ion species starts to elute from the separator and an end time at which the precursor ions stop eluting from the ion separator.

Step f) may comprise releasing the fragment or product ion species from the second ion accumulator in reverse order of mass to charge ratio, starting with ions of relatively high mass to charge ratio and progressively releasing ions of progressively lower mass to charge ratios, such that different ones of the fragment or product ion species simultaneously arrive at the pusher and are simultaneously pulsed into the time of flight region of the TOF mass analyser by the pusher electrode.

A transfer region may be provided between the second ion accumulator and the TOF mass analyser, wherein the pressure in the transfer region and the energies with which ions are released from second ion accumulator are such that fragment or product ions having relatively low mass to charge ratios catch up with fragment or product ions having a higher mass to charge ratio so that the ions simultaneously arrive at the pusher and are simultaneously pulsed into the time of flight region of the TOF mass analyser by the pusher electrode.

Optionally, substantially all of the fragment or product ion species released from the second ion accumulator, each time step f) is performed, arrive at the pusher at substantially the same time and are simultaneously pulsed into the time of flight region of the TOF mass analyser by the pusher electrode.

Step f) may comprise releasing all of the fragment or product ion species from the second ion accumulator at substantially the same time, wherein a transfer region is provided between the second ion accumulator and the TOF mass analyser, wherein ions are separated in the transfer region according to a second physicochemical property such that fragment or product ion species arrive at the TOF mass analyser at times that depend on their second physicochemical property value, and wherein the operation of the TOF mass analyser is synchronised with the release of ions from the second ion accumulator such that fragment or product ion species having a selected range of values of the second physicochemical property value are simultaneously pulsed into the time of flight region of the TOF mass analyser by the pusher electrode.

The method may comprise receiving an input signal, at a mass spectrometer performing the method, that is representative of said selected range of values of the second physicochemical property, and wherein said operation of the TOF mass analyser is synchronised with the release of ions from the second ion accumulator such that fragment or product ion species having said selected range of values of the second physicochemical property value are simultaneously pulsed into the time of flight region of the TOF mass analyser by the pusher electrode.

The second physicochemical property may be mass to charge ratio, such that ions are separated in the transfer region according to mass to charge ratio. For example, the operating conditions in the transfer region may be such that fragment or product ion species having relatively low mass to charge ratios travel therethrough faster than fragment or product ion species having a higher mass to charge ratio. For example, the product of the pressure P in the transfer region and the length of the ion flight path L through the transfer region (i.e. P×L) may be such that the ions substantially do not collide with background gas molecules in the transfer region.

Alternatively, the second physicochemical property may be ion mobility, such that ions are separated in the transfer region according to ion mobility. For example, the transfer region may act as an ion mobility separator configured to drive ions through a background gas arranged therein. The ions may be driven through the background gas by an electric field in order that they separate according to mobility. For example, the ions may be driven by applying a static DC potential gradient along the transfer region and/or by repeatedly travelling a DC potential along the transfer region. The electric field may be arranged so as to urge the ions in a downstream direction through the transfer region. Alternatively, the background gas may be flowed in the downstream direction and the electric field may be arranged to urge the ions in an upstream direction against the gas flow so as to cause the ions to separate according to mobility.

Steps a) to g) may be repeated during a single experimental run. For the avoidance of doubt, the term during a single experimental run means during the continual analysis of an analytical sample. For example, steps a) to g) may be repeated whilst ions are substantially continually generated (e.g. in a substantially continuous or pulsed manner) from an analytical sample, and/or during a single liquid or gas chromatography run.

The present disclosure also provides a mass spectrometer configured to perform the method described herein.

Accordingly, the first aspect of the present disclosure also provides a mass spectrometer comprising:
a first ion accumulator;
an ion separator;
a mass filter;
a fragmentation or reaction device;
a second ion accumulator;
a TOF mass analyser having a time of flight region and a pusher electrode; and
control circuitry configured to control the mass spectrometer to:
   a) accumulate precursor ions in the first ion accumulator;
   b) perform a separation cycle comprising pulsing a packet of the precursor ions out of the first ion accumulator and into the ion separator, and separating the precursor ions in the ion separator such that precursor ions having different values of a first physicochemical property elute from the ion separator at different times;
   c) mass filter the precursor ions that elute from the ion separator using the mass filter so as to transmit a selected precursor ion species;
   d) fragment or react the selected precursor ion species in the fragmentation or reaction device so as to generate a set of fragment or product ion species therefrom;
   e) accumulate the set of fragment or product ion species in the second ion accumulator;
   f) release the set of fragment or product ion species from the second ion accumulator into the TOF mass analyser, wherein operation of the TOF mass analyser is synchronised with the release of ions from the second ion accumulator such that multiple different species of the set of fragment or product ion species are simultaneously pulsed into the time of flight region of the TOF mass analyser by the pusher electrode; and
   g) repeat steps c) to f) at least once during said separation cycle, wherein the mass filter is controlled such that said selected precursor ion species is different each time steps c) to f) are performed.

The control circuitry may be configured to control the mass spectrometer such that step f) comprises releasing the fragment or product ion species from the second ion accumulator in reverse order of mass to charge ratio, starting with ions of relatively high mass to charge ratio and progressively releasing ions of progressively lower mass to charge ratios, such that different ones of the fragment or product ion species simultaneously arrive at the pusher and are simultaneously pulsed into the time of flight region of the TOF mass analyser by the pusher electrode.

The mass spectrometer may comprise a transfer region between the second ion accumulator and the TOF mass analyser, wherein the spectrometer is configured to maintain the pressure in the transfer region and release ions from the second ion accumulator with energies such that fragment or product ions having relatively low mass to charge ratios catch up with fragment or product ions having a higher mass to charge ratio so that the ions simultaneously arrive at the pusher and are simultaneously pulsed into the time of flight region of the TOF mass analyser by the pusher electrode.

The mass spectrometer may comprise a transfer region between the second ion accumulator and the TOF mass analyser; wherein the control circuitry is configured to control the mass spectrometer such that step f) comprises releasing all of the fragment or product ion species from the second ion accumulator into the transfer region at substantially the same time such that fragment or product ion species are separated in the transfer region according to a second physicochemical property and arrive at the TOF mass analyser at times that depend on their second physicochemical property value, and wherein the operation of the TOF mass analyser is synchronised with the release of ions from the second ion accumulator such that fragment or product ion species having a selected range of values of the second physicochemical property value are simultaneously pulsed into the time of flight region of the TOF mass analyser by the pusher electrode.

The mass spectrometer may comprise a user interface configured for inputting a selected range of values of the second physicochemical property; wherein the spectrometer is configured such that the control circuitry controls the operation of the TOF mass analyser, based on the selected range of values, to synchronise the operation of the TOF mass analyser with the release of ions from the second ion accumulator such that fragment or product ion species having said selected range of values of the second physicochemical property value are simultaneously pulsed into the time of flight region of the TOF mass analyser by the pusher electrode.

The mass spectrometer comprises an ion source. The mass spectrometer may also comprise a liquid or gas chromatography separator for separating an analytical sample upstream of the ion source.

The mass spectrometer may be configured to repeat steps a) to g) during a single experimental run, e.g. whilst ions are substantially continually generated (e.g. in a substantially continuous or pulsed manner) by the ion source and/or during a single liquid or gas chromatography separation run.

It is contemplated that the second ion accumulator could be omitted. In these embodiments, the second ion accumulator is not synchronised with the TOF mass analyser in order to control the fragment or product ions (from any given precursor ion species) that are mass analysed simultaneously by the TOF mass analyser. Rather, this is done by the operation of the TOF mass analyser being synchronised with the time at which the fragment or product ions are generated. Accordingly, the time that the mass filter transmits the selected precursor ion species to a fragmentation or reaction region is synchronised with the TOF mass analyser in order to control the fragment or product ions from the selected precursor ion species that are mass analysed simultaneously.

Accordingly, from a second aspect the present disclosure provides a method of mass spectrometry comprising:
a) accumulating precursor ions in a first ion accumulator;
b) performing a separation cycle comprising pulsing a packet of the precursor ions out of the first ion accumulator and into an ion separator, and separating the precursor ions such that precursor ions having different values of a first physicochemical property elute from the ion separator at different times;
c) switching a mass filter that mass filters the precursor ions that elute from the ion separator so as to begin transmitting a selected precursor ion species;
d) fragmenting or reacting the selected precursor ion species so as to generate a set or fragment or product ion species therefrom;
e) transferring the set of fragment or product ion species through a transfer region to a TOF mass analyser having a pusher electrode and a time of flight region, wherein ions are separated in the transfer region according to a second physicochemical property such that fragment or product ion species arrive at the TOF mass analyser at times that depend on their second physicochemical property values, and wherein the operation of the TOF mass analyser is synchronised with the time that the mass filter is switched so as to begin transmitting said selected precursor ion species such that fragment or product ion species having a selected range of values of the second physicochemical property that arrive at the pusher electrode substantially simultaneously are simultaneously pulsed into the time of flight region of the TOF mass analyser by the pusher electrode; and
f) repeating steps c) to e) at least once during said separation cycle, wherein said selected precursor ion species is different each time steps c) to e) are performed.

The fragment or product ion species of any given selected precursor ion species are subjected to a separation cycle in the transfer region, wherein the separation cycle is triggered based on the time at which the mass filter switches so as to start transmitting that precursor ion species.

The method may comprise receiving an input signal, at a mass spectrometer performing the method, that is representative of said selected range of values of the second physicochemical property and then controlling said operation of the TOF mass analyser such that fragment or product ion species having said selected range of values of the second physicochemical property arrive at the pusher electrode substantially simultaneously and are simultaneously pulsed into the time of flight region of the TOF mass analyser by the pusher electrode.

The fragment or product ions of any given precursor ion species may arrive at the TOF mass analyser at a time that is correlated to the time that the mass filter begins to transmit their precursor ion species. For example, the selected precursor ion species transmitted in step c) may not be axially trapped prior to said fragmenting or reacting in step d); and the fragment or product ions generated in step d) may not be axially trapped before arriving at the TOF mass analyser.

The method according to the second aspect of the present disclosure may have any of the features described in relation to the first aspect of the present disclosure, except that it need not use the second ion accumulator.

For example, each time step c) is performed, only the selected precursor ion species may be transmitted and no other precursor ion species are transmitted. Alternatively, each time that step c) is performed, the mass filter may transmit precursor ions having a restricted range of mass to charge ratios, such that multiple precursor ion species are transmitted simultaneously, whereas precursor ions having mass to charge ratios outside of this restricted range are filtered out. Step d) may then comprise simultaneously fragmenting or reacting the multiple precursor ion species transmitted so as to generate multiple respective sets of fragment or product ion species therefrom. Step e) may comprise transferring the multiple sets of fragment or product ion species through a transfer region to the TOF mass analyser, wherein the operation of the TOF mass analyser is synchronised with the time that the mass filter is switched so as to begin transmitting said precursor ion species such that fragment or product ion species having a selected range of values of the second physicochemical property arrive at the pusher electrode substantially simultaneously and are simultaneously pulsed into the time of flight region of the TOF mass analyser by the pusher electrode. Step f) may comprise repeating steps c) to e) at least once during the separation cycle, wherein said range of mass to charge ratios that is transmitted by the mass filter is different each time steps c) to e) are performed.

The present disclosure also provides a mass spectrometer configured to perform the method described in relation to the second aspect of the present disclosure.

Accordingly, the present disclosure provides a mass spectrometer comprising:
a first ion accumulator;
an ion separator;
a mass filter;
a fragmentation or reaction device;
a TOF mass analyser having a time of flight region and a pusher electrode;
a transfer region between the fragmentation or reaction device and the TOF mass analyser; and
control circuitry configured to control the mass spectrometer to:
   a) accumulate precursor ions in the first ion accumulator;
   b) perform a separation cycle comprising pulsing a packet of the precursor ions out of the first ion accumulator and into the ion separator, and separating the precursor ions in the ion separator such that precursor ions having different values of a first physicochemical property elute from the ion separator at different times;
   c) switch a mass filter that mass filters precursor ions that elute from the ion separator so as to begin transmitting a selected precursor ion species;
   d) fragment or react the selected precursor ion species in the fragmentation or reaction device so as to generate a set of fragment or product ion species therefrom;
   e) transfer the set of fragment or product ion species through the transfer region to the TOF mass analyser, wherein ions are separated in the transfer region according to a second physicochemical property such that fragment or product ion species arrive at the TOF mass analyser at times that depend on their second physicochemical property values, and wherein the operation of the TOF mass analyser is synchronised with the time that the mass filter is switched so as to begin transmitting said selected precursor ion species such that fragment or product ion species having a selected range of values of the second physicochemical property that arrive at the pusher electrode substantially simultaneously are simultaneously pulsed into the time of flight region of the TOF mass analyser by the pusher electrode; and
   f) repeat steps c) to e) at least once during said separation cycle, wherein said selected precursor ion species is different each time steps c) to e) are performed.

### BRIEF DESCRIPTION OF THE DRAWINGS

Various embodiments of the present invention will now be described, by way of example only, and with reference to the accompanying drawings in which:

FIG. 1 shows a schematic of an embodiment of a mass spectrometer according to the present disclosure;

FIG. 2 represents an example of how a mass filter may be controlled as a function of time so as to selectively transmit different precursor ion species over different time periods;

FIG. 3 shows the same plot as FIG. 2, except with fragment or product ion species superimposed;

FIG. 4 shows an example of how fragment or product ions may be mass analysed by a TOF mass analyser;

FIG. 5 shows how the mass spectrometer of FIG. 1 may be operated according to an embodiment of the present disclosure;

FIG. 6 illustrates how the process described in relation to FIG. 5 may be repeated multiple times for different precursor ion species that elute from an ion separator during the same separation cycle;

FIG. 7 shows how the mass spectrometer of FIG. 1 may be operated according to another embodiment of the present disclosure; and

FIG. 8 illustrates how the process described in relation to FIG. 7 may be repeated multiple times for different precursor ion species that elute from an ion separator during the same separation cycle.

### DETAILED DESCRIPTION

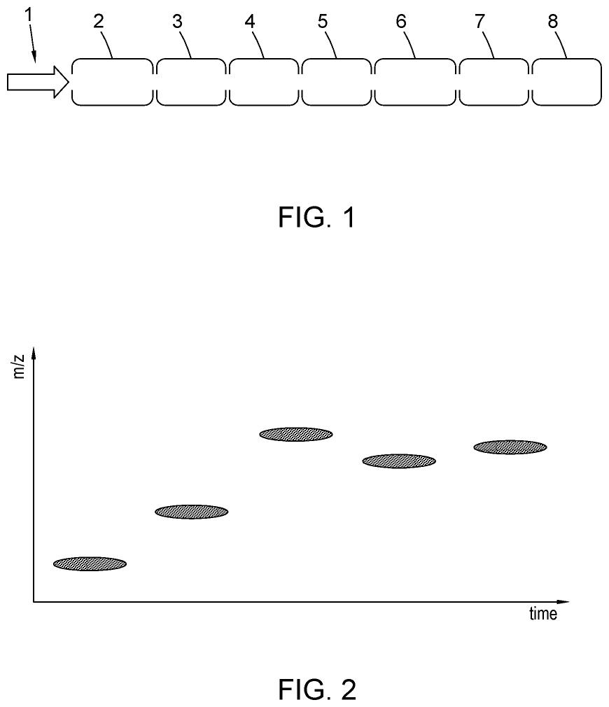

FIG. 1 shows a schematic of an embodiment of a mass spectrometer according to the present disclosure. The spectrometer comprises a source of ions 1, a first ion accumulator 2, an ion separator 3, a mass filter 4, a fragmentation or reaction device 5, a second ion accumulator 6, a transfer region 7 and a time of flight (TOF) mass analyser 8.

It will be appreciated that other ion-optical devices may also be provided in the spectrometer, such as one or more RF ions guides, electrostatic lenses, or collisionally cooled RF ions guides that are configured to urge ions through them such as by using an axial electric field or by travelling electric potential barriers along them.

In use, ions are supplied from the source of ions 1, which may be an ion source that generates ions from an analytical sample, or may be an ion-optical device that supplies ions. The ions from the source 1 may be accumulated in the first ion accumulator 2 and then released into the separator 3 as a packet of ions. The ion accumulator 2 may accumulate ions and periodically pulse them into the separator 3. The accumulator 2 may be configured to allow ions to continually enter it, or ions may be blocked from entering the accumulator 2 at the times that the packets of ions are being pulsed into the separator 3. Either way, the accumulator 2 accumulates ions from the source 1 in the time periods between the times at which packets of ions are pulsed into the separator 3.

The separator 3 is controlled so as to cause each packet of ions received from the accumulator 2 to be separated according to one or more physicochemical property. For example, the separator 3 may separate the ions according to ion mobility or mass to charge ratio, or a combination of both of these physicochemical properties. The separated ions then pass from the separator 3 to the mass filter 4. The mass filter 4 is controlled such that it is only able to transmit a single mass to charge ratio (or a restricted range of mass to charge ratios) at any given time, wherein the single mass to charge ratio (or the restricted range) is varied with time as the separated ions from the ion packet elute from the separator 3.

FIG. 2 represents an example of how the mass filter 4 may be controlled as a function of time, as the separated ions from the ion packet elute from the separator 3. More specifically, FIG. 2 shows a plot of the mass to charge ratios that are transmitted by the mass filter 4 as a function of time since the packet of ions was pulsed into the separator 3. In this example, the mass filter 4 is controlled such that at a first time it only transmits ions having a first, relatively low, mass to charge ratio. The mass filter is then controlled such that at a second, later time it only transmits ions having a second, higher mass to charge ratio. The mass filter is then controlled such that at a third, later time it only transmits ions having a third, higher mass to charge ratio. The mass filter is then controlled such that at a fourth, later time it only transmits ions having a fourth, lower mass to charge ratio. The mass filter is then controlled such that at a fifth, later time it only transmits ions having a fifth, higher mass to charge ratio.

The mass filter 4 may be, for example, a resolving quadrupole mass filter, although it is contemplated that other types of mass filter could be used. It will also be appreciated that the mass filter 4 may be controlled so as to transmit different mass to charge ratios at different times in manners other than those shown in the example of FIG. 2.

After a delay time, another packet of ions may be pulsed from the ion accumulator 2 into the separator 3 and the above process may be repeated so as to separate and filter the ions in this new packet. The delay time may be the time it takes for all of the ions of interest in one ion packet (i.e. those that the mass filter 4 is set to transmit at some point in time) to pass through the separator 3 and to the filter 4, although it could be set to be a shorter or longer delay time if desired. Any desired number of ion packets may be sequentially separated and then filtered in the manner described above.

The separated ions that are transmitted by the filter 4 (i.e. rather than being filtered out by it) are transferred to the fragmentation or reaction device 5. The fragmentation or reaction device 5 may be a Collision Induced Dissociation (CID) device, an Electron Capture Dissociation (ECD) device, an Electron Transfer Dissociation (ETD) device, a Surface Induced Dissociation (SID), or a device that fragments ions according to any other technique. For example, the device may react the ions with reagent ions or molecules so as to cause the ions to fragment, or a device may be used to react the ions with reagent ions or molecules to form other types of product ions such as adduct ions.

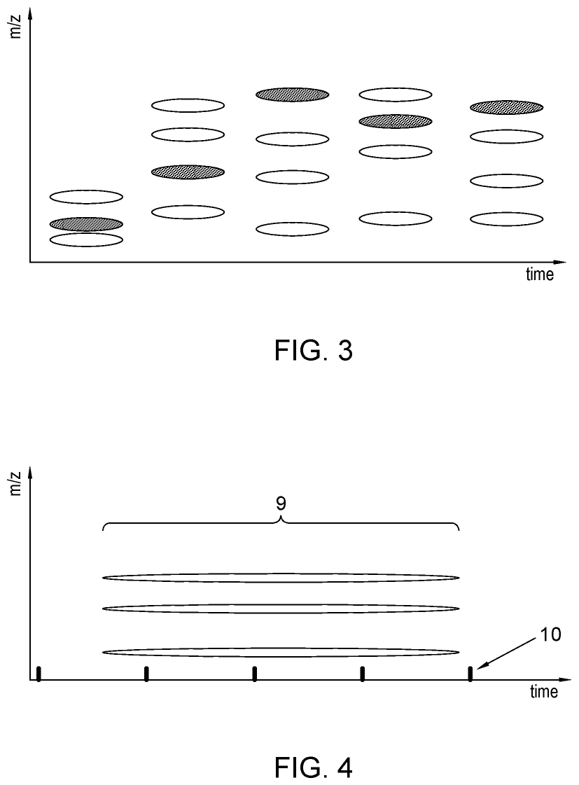

FIG. 3 shows the same plot as FIG. 2, except with the fragment or product ion species that are generated from the precursor ions superimposed. In the example shown, the first precursor species transmitted by the mass filter 4 is shown as the first dark oval and it has been fragmented or reacted to generate two species of fragment or product ions, which are shown by the lighter coloured ovals above and below the first dark oval. In this example, one of the fragment or product ion species has a higher mass to charge ratio than the first precursor species and the other has a lower mass to charge ratio. In this example, each of the second to fifth precursor species (which are represented by the dark ovals) is fragmented or reacted to generate three species of fragment or product ions (which are represented by the lighter ovals).

It will be appreciated that the different precursor ions arrive at the fragmentation or reaction device 5 at different times, due to their separation in the separator 3, and that therefore the different precursor ions are fragmented or reacted at different times so as to produce their fragment or product ions at different times. Although FIG. 3 shows the fragment or product ion species being generated over time periods that exactly align with the time period over which their precursor ion species is transmitted by the filter 4, it will be appreciated that this may not be the case and that the period over which any given fragment or product ion species is generated may be offset from the time at which its precursor ion species was transmitted by the filter 4, e.g. due to the transit time of the precursor ion species to (or through) the fragmentation or reaction device 5, and/or the time it takes for the precursor species to undergo fragmentation or reaction in the device 5.

The separation of the precursor ion species that was induced by the separator 3 may be preserved between the fragment or product ion species derived from these precursor ion species. In particular, the different precursor ion species arrive at the fragmentation or reaction device 5 at different times and so their respective fragment or product ion species are generated at corresponding different times. The fragment or product ion species may be urged through and out of the fragmentation or reaction device 5 such that the fragment or product ion species that are derived from different precursor species arrive at the second ion accumulator 6 at different respective times. Accordingly, fragment or product ion species that are derived from the same precursor species arrive at the second ion accumulator 6 over substantially the same time period and are accumulated in the second ion accumulator.

The second ion accumulator 6 accumulates ions and periodically pulses them into the transfer region 7. The second ion accumulator 6 may be configured to allow ions to continually enter it, or ions may be blocked from entering the accumulator 6 at the times that the packets of ions are being pulsed into the transfer region 7. Either way, the accumulator accumulates ions from the fragmentation or reaction device 5 in the time periods between the times at which packets of ions are pulsed from the accumulator 6 into the transfer region 6. It is however contemplated that the second ion accumulator 6 may be omitted and the fragmentation or reaction device 5 may pulse ions into the transfer region 7 instead, e.g. by providing an ion gate between the fragmentation or reaction device 5 and the transfer region 7. Alternatively, the second ion accumulator 6 and fragmentation or reaction device 5 may be two parts of the same device.

The fragment or product ions are transferred through the transfer region 7 to the TOF mass analyser 8. As is well known in the art, the TOF mass analyser 8 has a pusher that pulses a packet of ions into a time of flight region (e.g. a field-free region) and towards an ion detector. The ions separate out according to their mass to charge ratios as they pass through the time of flight region, and then strike the ion detector. As such, the separated ions arrive at the ion detector at different times, wherein the time at which an ion arrives at the detector is related to its mass to charge ratio. The mass to charge ratio of any given ion can be determined from the duration of time between the time at which it was pulsed into the time of flight region and the time at which it was detected by the ion detector. The TOF mass analyser 8 is therefore able to obtain data from the signal detected at the detector and determine the mass to charge ratios of the ions pulsed into the mass analyser 8, and their intensities, and form a mass spectrum.

The ions may be reflected by one or more ion mirror between the pusher and the ion detector in order to provide a relatively long flight path through the time of flight region. This enables ions of different mass to charge ratios to separate out to a greater degree as they travel though the time of flight region and hence provides the TOF mass analyser 8 with a higher mass resolution. The TOF mass analyser 8 may therefore be a Multi-Reflecting TOF (MRTOF) mass analyser that reflects the ions multiple times using ion mirrors as the ions drift from the pusher towards the ion detector.

The fragment or product ions that are derived from any given species of precursor ion arrive at the TOF mass analyser 8 within a restricted time period that is related to the time period over which their precursor species exit the separator 3.

FIG. 4 shows an example of how fragment or product ions are mass analysed by a TOF mass analyser 8 according to a conventional (non-Encoded Frequent Pulsing) approach. In this example, three species of fragment or product ions having three different mass to charge ratios are generated from a single precursor species within the fragmentation or reaction device 5 and are then transmitted from the second ion accumulator 6, through the transfer region 7 and to the TOF mass analyser 8 over the same time period. The three species of fragment or product ions arrive at the pusher of the TOF mass analyser 8 over the time window 9 shown in FIG. 4. The TOF mass analyser 8 periodically pulses the pusher, which therefore repeatedly samples the fragment or product ions throughout time window 9 and mass analyses them. The times at which the TOF pusher is pulsed are illustrated by the vertical lines 10 on the x-axis. These multiple pulses 10 of the TOF pusher during duration 9 cause multiple TOF mass spectra to be generated for the fragment or product ions derived from each precursor ion.

Although FIG. 4 only shows the fragment or product ions from one of the precursor species transmitted by the filter 4, it will be appreciated that the fragment or product ions derived from the other precursor ion species that are transmitted by the filter 4 (at respective later or earlier times to said one of the species) will also be mass analysed in the TOF mass analyser 8 in a corresponding manner (at a later or earlier time respectively). This conventional data acquisition scheme has proven useful, e.g. as it enables accurate measurements to be made in the separation time domain of separator 3, and hence ultimately allowing physicochemical properties such as the ion mobility and collision cross section to be determined. This approach also allows processing software to group together the fragment or product ions that are common to the same precursor species.

However, the approach illustrated by FIG. 4 provides the TOF mass analyser 8 with a relatively low sampling duty cycle. This is because a relatively long duration is provided between any given pusher pulse 10 and the next pusher pulse, in order to allow time for the heaviest mass to charge ratio ion pushed by said given pusher pulse to arrive at the ion detector of the TOF analyser 8 before another packet of ions is pushed toward the ion detector by said next pusher pulse. This means that the duration between the pusher pulses 10 is equal to or greater than the time of flight from the pusher to the detector of the maximum mass to charge ratio that is desired to be detected. As such, the sampling duty cycle reduces with the square root of the maximum mass to charge ratio that is desired to be detected. The TOF sampling duty cycle according to such techniques is typically in the range of from 0.1% to 50%. These values are typical maximum duty cycles.

To improve the overall experimental duty cycle of the spectrometer, the transfer of ions between various components of the spectrometer is synchronised.

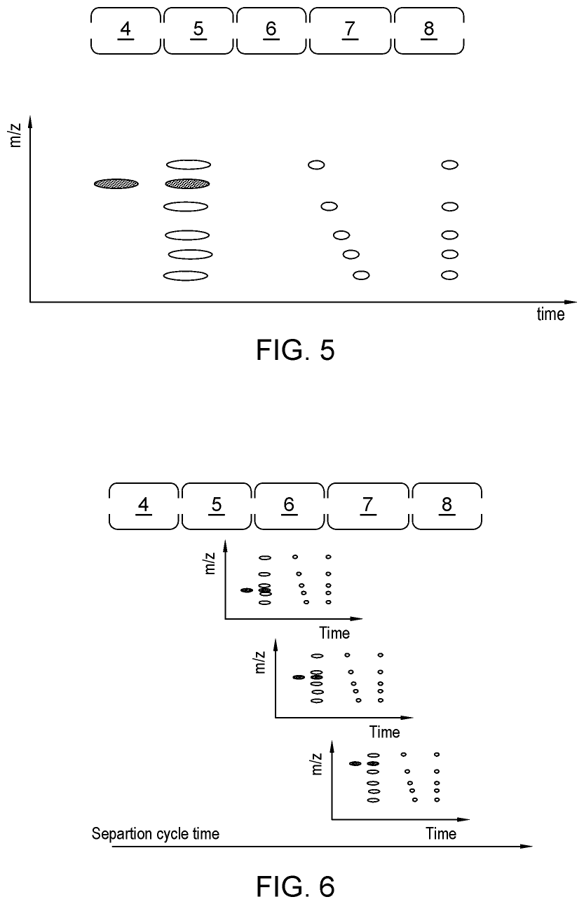

FIG. 5 shows how the mass spectrometer of FIG. 1 may be operated according to embodiments of the present disclosure. The upper portion of FIG. 5 schematically illustrates part of the spectrometer of FIG. 1, whereas the lower portion of FIG. 5 shows a plot illustrating how a precursor species of ion is analysed in the spectrometer. The plot shows an example of the mass to charge ratios of the ions (y-axis) that are present at the different regions of the spectrometer that are shown, i.e. at different times (x-axis).

As described above in relation to FIG. 1, the separator 3 performs a separation cycle in which different ion species are pulsed from the first accumulator 2 into the separator 3, are separated therein according to a physicochemical property, and then elute at different times according to their physicochemical property values. The ions that elute from the separator 3 are received at the mass filter 4. At any given time during the separation cycle of the ion separator 3, the mass filter 4 may be configured so as to only be able to transmit a selected mass to charge ratio, or selected range of mass to charge ratios, e.g. such that only a single precursor ion species is able to be transmitted. In FIG. 5, this is illustrated by the dark oval below the mass filter 4, which represents a first precursor ion species having a certain mass to charge ratio being transmitted by the mass filter over a time period. The precursor species is then transmitted into the fragmentation or reaction device 5, where it is fragmented or reacted so as to form fragment or product ions. This process is illustrated in FIG. 5 by the six ovals that are arranged in a column below the fragmentation or reaction device 5. The dark oval represents the precursor species, whereas the five lighter ovals represent the different species of fragment or product ions that are generated from the precursor species. It will be appreciated that fewer or more than five different types of fragment or product ions may be generated. Also, some of the precursor ions may, or may not, be present after the fragmentation or reaction.

The fragment or product ions are then transferred into the second ion accumulator 6 during an ion accumulation period. After this ion accumulation period, the different species of fragment or product ions are released from the second ion accumulator 6 into the transfer region 7 at different times. More specifically, the fragment or product ions are released from the ion accumulator 6 in reverse order of mass to charge ratio, i.e. the highest mass to charge ratio fragment or product ion species is released first and then progressively lower mass to charge ratio fragment or product species are released in sequence. This is illustrated in FIG. 5 by the five fragment or product species shown below the transfer region 7. The spacing of the five fragment or product species along the time axis illustrates that the fragment or product ion species having the highest mass to charge ratio is released first, followed by releasing progressively lower mass to charge ratio fragment or product ion species at progressively later, respective times.

The manner in which the fragment or product ion species are released from the second ion accumulator 6, and the manner in which the transfer region 7 is configured, are selected such that at least some of the different fragment or product ion species arrive at the TOF mass analyser 8 at substantially the same time. This is illustrated in FIG. 5 by the column of five fragment or product ion species shown below the TOF mass analyser 8. For example, the different fragment or product species may be released from the ion accumulator 6 having substantially the same energy and the transfer region 7 may be maintained at a relatively low pressure such that there are relatively few collisions between the ions and the background gas, as the ions travel to the TOF mass analyser 8. It will be appreciated that under these conditions the transfer region 7 operates as a time of flight region in which ions having a relatively low mass to charge ratio travel faster than ions having a higher mass to charge ratio. As such, fragment or product ion species having relatively low mass to charge ratios, which are released from the ion accumulator 6 after heavier fragment or product ion species (i.e. having higher mass to charge ratios), catch up with the heavier fragment or product ion species so as to arrive at the TOF mass analyser 8 at substantially the same time as them. The pusher of the TOF mass analyser 8 is synchronised with the release of ions from the ion accumulator 6 so as to pulse the pusher at the time that multiple different species of fragment or product ions simultaneously arrive at the pusher of the TOF mass analyser 8. As such, the TOF mass analyser is provided with a relatively high duty cycle.

The second ion accumulator 6 may be a mass selective ion trap. The ion trap may be a 3D quadrupole field ion trap or a linear ion trap. Ions may be ejected from the ion trap, into the transfer region 7 and toward the TOF mass analyser 8, in reverse order of mass to charge ratio. This may be achieved in various ways, as is known in the art. For example, an RF voltage and/or DC voltage applied to electrodes of the ion trap may be varied with time (e.g. scanned) so as to sequentially cause ions of decreasing mass to charge ratios to become unstable in the ion trap and hence be ejected into the transfer region 7 and towards the TOF mass analyser 8. Alternatively, or additionally, an AC voltage may be applied to the electrodes of the ion trap so as to resonantly excite and eject ions of a specific mass to charge ratio from the ion trap, into the transfer region 7 and towards the TOF mass analyser 8. The frequency of this AC voltage may be varied with time (e.g. scanned) so as to sequentially eject ions of decreasing mass to charge ratios. For example, the accumulator 6 may mass selectively eject ions in order of decreasing mass to charge ratio as described in U.S. Pat. No. 6,770,872, which is incorporated herein by reference.

The inventors have recognised that the timescale over which the second ion accumulator 6 is able to accumulate fragment or product ions and release them, in reverse order of mass to charge ratio, is comparable with the timescale over which any given precursor ion elutes from the upstream separator 3. For example, in embodiments the second ion accumulator 6 accumulates and releases the fragment or product ion species from any given precursor ion species over a period of approximately 1 ms, which is approximately the same time period that a precursor ion species elutes from the separator 3. As such, fragment or product ion species derived from a first precursor ion species that elutes from the ion separator 3 during a given separation cycle of the separator 3 are able to be accumulated, trapped and released (in reverse order of mass to charge ratio) before a second precursor ion species elutes from the ion separator 3 within the same separation cycle of the separator 3. This is described in more detail in relation to FIG. 6. As such, the mass spectrometer has a relatively high duty cycle, since precursor ions are fragmented and analysed whilst other precursor ions remain delayed in the separator, rather than being discarded.

FIG. 6 illustrates how the process described in relation to FIG. 5 may be repeated multiple times for different precursor ion species that elute from the separator 3 during the same separation cycle.

The lower plot in FIG. 6 corresponds to the process described in relation to FIG. 5, wherein a first precursor ion species that elutes from the separator 3 is fragmented or reacted, and the resulting fragment or product ions are accumulated in accumulator 6 and then released in reverse order of mass to charge ratio to the TOF mass analyser 8.

The middle plot in FIG. 6 shows the same process being performed on a second precursor ion species that elutes from the separator 3 during the same separation cycle of the separator as the first precursor ion species, but at an earlier time. More specifically, according to the middle plot in FIG. 6, the mass filter 4 is set so as to transmit the second precursor ion species, which is represented by the dark oval in the middle plot. The second precursor ion species is then transmitted into the fragmentation or reaction device 5, where it is fragmented or reacted so as to form fragment or product ions. This is illustrated by the five lighter ovals that are arranged in a column with the dark oval, although it will be appreciated that fewer or more than five different types of fragment or product ions may be generated. The fragment or product ions derived from second precursor ion species are then transferred to the second ion accumulator 6 and released therefrom in reverse order of mass to charge ratio such that at least some of the different fragment or product ion species arrive at the TOF mass analyser 8 at substantially the same time.

The upper plot in FIG. 6 shows the same process being performed on a third precursor ion species that elutes from the separator 3 during the same separation cycle of the separator as the first and second precursor ion species, but at an earlier time. More specifically, according to the upper plot in FIG. 6, the mass filter 4 is set so as to transmit the third precursor ion species, which is represented by the dark oval. The third precursor ion species is then transmitted into the fragmentation or reaction device 5, where it is fragmented or reacted so as to form fragment or product ions. This is illustrated by the five lighter ovals that are arranged in a column with the dark oval, although it will be appreciated that fewer or more than five different types of fragment or product ions may be generated. The fragment or product ions are then transferred to the second ion accumulator 6 and released therefrom in reverse order of mass to charge ratio such that at least some of the different fragment or product ion species arrive at the TOF mass analyser 8 at substantially the same time.

The mass spectrometer may be configured so as to only allow fragment or product ions derived from any given precursor ion species to enter the accumulator 6 after all of the fragment or product ions derived from the precursor ion species that was previously analysed have been ejected from the accumulator. This may be achieved, for example, by the spectrometer controlling the time that the mass filter 4 switches to being capable of transmitting said given precursor ion species to being at, or after, the time that the accumulator 6 has ejected the lightest mass to charge ratio fragment or product ion derived from the preceding precursor ion species. Alternatively, an ion gate may be provided upstream of the accumulator 6 that is controlled by the spectrometer so as to prevent ions entering the accumulator until the accumulator 6 has been controlled to eject all of the fragment or precursor ions in reverse order of mass to charge ratio.

Although three precursor ion species are shown as being analysed during a single separation cycle of the separator 3, it is contemplated that only two species of precursor ions, or more than three species of precursor ions, may be sequentially analysed in the manner described during a single separation cycle.

Furthermore, although the method has only so far been described in the context of the separator 3 performing a single separation cycle, it will be appreciated that multiple separation cycles may be performed during the same experimental run and that the above described method may be repeated for each of these separation cycles during the experimental run.

The above described method of synchronising the transfer of ions between various components of the spectrometer improves the overall experimental duty cycle of the spectrometer. For instance, the mass filter 4 is synchronised with the ion separator 3 such that, during a single separation cycle of the separator 3, the mass filter 4 switches between transmitting different precursor ion species at different times. The precursor ions transmitted by the mass filter 4 are fragmented or reacted in the fragmentation or reaction device 5 and then pass to the second ion accumulator 6. The second ion accumulator 6 is synchronised with the mass filter 4 (and hence also synchronised with the ion separator 3) such that, during a single separation cycle of the separator 3: (i) a first set of fragment or product ions that are derived from a first precursor ion species, that elutes from the separator 3 and is transmitted by the mass filter 4, are accumulated in the second ion accumulator 6 and then released into the transfer region 7; and (ii) a second set of fragment or product ions that are derived from a second precursor ion species, that elutes from the separator 3 and is transmitted by the mass filter 4, are accumulated in the second ion accumulator 6 and then released into the transfer region 7. As such, the mass spectrometer has a relatively high duty cycle, since precursor ions are fragmented and analysed whilst other precursor ions remain delayed in the separator 3, rather than being discarded. Also, the TOF mass analyser 8 may be synchronised with the release of ions from the second ion accumulator 6 so that the pusher of the TOF mass analyser is pulsed when multiple fragment or product ion species from the same precursor simultaneously arrive at the pusher. As such, the TOF mass analyser is provided with a relatively high duty cycle.

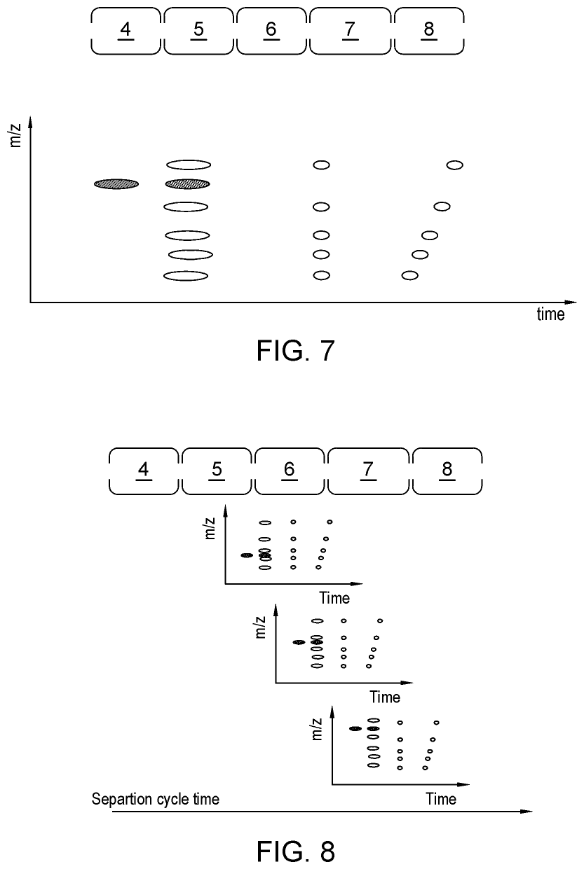

FIG. 7 illustrates another method according to the present disclosure that is the same as that described above in relation to FIGS. 5 and 6, up until the point that the fragment or product ions are ejected from the second ion accumulator 6. In the embodiment illustrated by FIG. 7, the different fragment or product ion species are ejected from the second ion accumulator 6 and into the transfer region 7 at substantially the same time. This is illustrated in FIG. 7 by the five fragment or product species shown below the transfer region 7.

The transfer region 7 is configured so as to cause the fragment or product ion species to separate according to a physicochemical property. For example, the ions may be separated according to ion mobility or mass to charge ratio, or a combination of both of these physicochemical properties, in the transfer region 7. For instance, the transfer region 7 may be maintained at a relatively low pressure such that there are relatively few collisions between the ions and the background gas therein, as the ions travel to the TOF mass analyser 8. It will be appreciated that under these conditions the transfer region 7 operates as a time of flight region in which the ions will separate according to mass to charge ratio. As such, fragment or product ion species having relatively low mass to charge ratios will arrive at the TOF mass analyser 8 before ions having higher mass to charge ratios. This is depicted in FIG. 7 by the five fragment or product ion species shown below the TOF mass analyser 8. These species are shown spaced apart on the time axis, illustrating that the smallest mass to charge ratio fragment or product ion species arrive at the TOF mass analyser 8 first, followed by progressively higher mass to charge ratio fragment or product ion species arriving at progressively higher, respective times.

Alternatively, the fragment or product ion species may be pulsed into the transfer region 7 and separated therein according to their mobility through a background gas arranged in the transfer region 7. The ions may be driven through the background gas by an electric field in order that they separate according to mobility. For example, the ions may be driven by applying a static DC potential gradient along the transfer region 7 and/or by repeatedly travelling a DC potential along the transfer region 7. The electric field may be arranged so as to urge the ions through the transfer region 7 towards the TOF mass analyser 8. Alternatively, the background gas may be flowed in a direction so as to urge the ions towards the TOF mass analyser 8, whereas the electric field may be arranged to urge the ions against the gas flow so as to cause the ions to separate according to mobility.

In these mobility separation embodiments the ions pulsed into the transfer region 7 may be caused to arrive at the TOF mass analyser 8 in order of increasing or decreasing mobility. In the embodiments described in relation to FIG. 7, the transfer region 7 acts as an ion separator that performs a separation cycle in which different ion species are pulsed into the transfer region 7, are separated therein according to a physicochemical property, and then elute to the mass analyser 8 at different times according to their physicochemical property values. This separation cycle may be shorter than the separation cycle of the ion separator 3.

After separation of the ions in the transfer region 7 according to the physicochemical property, the ions may be transferred into an ion guide that guides the separated ions to the TOF mass analyser 8 whilst maintaining their separation. For example, voltages may be applied to the ion guide so as to generate a series of potential wells (and hence potential barriers) that are axially spaced along the ion guide. The voltages may be DC voltages, although it is contemplated that alternatively pseudo-potential wells could be formed by using AC voltages. The voltages applied to the electrodes may be varied with time such that the series of potential wells move from the upstream end of the ion guide, along the ion guide and to the TOF mass analyser 8. As ions having different values of the physicochemical property arrive at the upstream end of the ion guide at different times, ions having different ranges of values of the physicochemical property become trapped in different potential wells and hence are translated in the wells to arrive at the TOF mass analyser 8 at different times. The ion guide may operate, for example, in the same manner as the ion guide described in U.S. Pat. No. 7,829,841, which is incorporated herein by reference.

In the embodiments illustrated in FIG. 7, fragment or product ions having a restricted range of the physicochemical property (which the transfer region 7 separates the ions according to) arrive at the pusher of the TOF mass analyser 8 at the same time, and the pusher may be synchronised with the release of ions from the second ion accumulator 6 so that the pusher pulses ions having this selected range of physicochemical properties into the time of flight region of the TOF mass analyser 8.

FIG. 8 illustrates how the process described in relation to FIG. 7 may be repeated multiple times for different precursor ion species that elute from the first ion separator 3 during the same separation cycle.

The lower plot in FIG. 8 corresponds to the process described in relation to FIG. 7, wherein a first precursor ion species that elutes from the separator 3 is fragmented or reacted, and the resulting fragment or product ions are accumulated and then released all at once to the TOF mass analyser 8.

The middle plot in FIG. 8 shows the same process being performed on a second precursor ion species that elutes from the separator 3 during the same separation cycle of the separator 3 as the first precursor ion species, but at an earlier time. More specifically, according to the middle plot in FIG. 8, the mass filter 4 is set so as to transmit the second precursor ion species, which is represented by the dark oval in the middle plot. The second precursor ion species is then transmitted into the fragmentation or reaction device 5, where it is fragmented or reacted so as to form fragment or product ions. This is illustrated by the five lighter ovals that are arranged in a column with the dark oval, although it will be appreciated that fewer or more than five different types of fragment or product ions may be generated. The fragment or product ions derived from second precursor ion species are then transferred to the second ion accumulator 6 and released all at once therefrom such that different fragment or product ion species arrive at the TOF mass analyser 8 at different times.

The upper plot in FIG. 8 shows the same process being performed on a third precursor ion species that elutes from the separator 3 during the same separation cycle of the separator as the first and second precursor ion species, but at an earlier time. More specifically, according to the upper plot in FIG. 8, the mass filter 4 is set so as to transmit the third precursor ion species, which is represented by the dark oval. The third precursor ion species is then transmitted into the fragmentation or reaction device 5, where it is fragmented or reacted so as to form fragment or product ions. This is illustrated by the five lighter ovals that are arranged in a column with the dark oval, although it will be appreciated that fewer or more than five different types of fragment or product ions may be generated. The fragment or product ions are then transferred to the second ion accumulator 6 and released all at once therefrom such that the different fragment or product ion species arrive at the TOF mass analyser 8 at different times.

The mass spectrometer may be configured so as to only allow fragment or product ions derived from any given precursor ion species to enter the second ion accumulator 6 after all of the fragment or product ions derived from the precursor ion species that was previously analysed have been ejected from the accumulator 6. This may be achieved, for example, by the spectrometer controlling the time that the mass filter 4 switches to being capable of transmitting said given precursor ion species to being at, or after, the time that the accumulator 6 has ejected the fragment or product ions derived from the preceding precursor ion species. Alternatively, an ion gate may be provided upstream of the accumulator 6 that is controlled by the spectrometer so as to prevent ions entering the accumulator 6 until the accumulator 6 has been controlled to eject all of the fragment or precursor ions.

Although three precursor ion species are shown as being analysed during a single separation cycle of the separator 3, it is contemplated that only two species of precursor ions, or more than three species of precursor ions, may be sequentially analysed in the manner described during a single separation cycle.

Furthermore, although the method has only so far been described in the context of the separator 3 performing a single separation cycle, it will be appreciated that multiple separation cycles may be performed during the same experimental run and that the above described method may be repeated for each of these separation cycles during the experimental run.

Although the present invention has been described with reference to preferred embodiments, it will be understood by those skilled in the art that various changes in form and detail may be made without departing from the scope of the invention as set forth in the accompanying claims.

For example, although embodiments have been described in relation to FIGS. 7-8 in which the second ion accumulator 6 is present, it is contemplated that the second ion accumulator 6 may be omitted. In such embodiments each precursor ion species may be fragmented or reacted in the fragmentation or reaction device 5, without trapping the ions, and the resulting fragment or product ions that are generated are transferred into the transfer region 7 without having been trapped. In such embodiments the fragment or product ions of any given precursor ion species will enter the transfer region 7 at a time that is correlated to the time that the mass filter 4 begins to transmit the precursor ion species. The start of the separation cycle in the transfer region 7, for the fragment or product ions of any given precursor ion species, is therefore be triggered by the time at which the mass filter 4 switches so as to start transmitting that precursor ion species. As described above, fragment or product ions having a restricted range of the physicochemical property arrive at the pusher of the TOF mass analyser 8 at different times. The pusher may be synchronised with the time that the mass filter 4 switches to transmit a new precursor ion species so that the pusher pulses ions having a selected range of physicochemical properties into the time of flight region of the TOF mass analyser 8.

Embodiments have been described herein in which the spectrometer includes a first ion accumulator 2 and/or a second ion accumulator 6. An ion attenuation device may be provided upstream of the first and/or second ion accumulator so as to attenuate ions travelling towards them. This may be used to reduce the number or ions entering the ion accumulators 2,6 and, for example, to reduce space-charge effects in the ion accumulators and/or to prevent saturation of the detector in the TOF mass analyser 8. Additionally, or alternatively, an ion attenuation device may be provided downstream of the first and/or second ion accumulator 2,6 so as to attenuate ions travelling downstream therefrom. This may be used, for example, to prevent saturation of the detector in the TOF mass analyser 8.

Although the mass filter 4 has been described as being stepped between different, discrete mass transmission windows as the ions elute from the separator 3, it is contemplated that the mass filter 4 may instead have a mass transmission window that is progressively scanned. For example, the mass transmission window may increase by one mass to charge ratio unit at a time. Alternatively, the mass filter 4 may have a mass transmission window that is configured to be able to simultaneously transmit a range of mass to charge ratios (e.g. a range consisting of multiple Da). This mass transmission window may be progressively scanned such that each time the mass transmission window is moved for transmitting a new mass range, the new mass range still partially overlaps with the previous mass range that the filter 4 had been configured to transmit.

Alternatively, or additionally, although the filter 4 has been described as a mass to charge ratio filter, it is contemplated that the filter may filter ions according to another physicochemical property such as ion mobility or FAIMS etc.

Alternatively, or additionally, although the separator 3 has been described as an ion mobility separator, it is contemplated that the separator may separate ions according to another physicochemical property, such as mass to charge ratio.

In less preferred embodiments it is contemplated that the first ion accumulator 2 may be omitted and the source 1 may pulse ions into the separator 3 instead, e.g. by being a pulsed ion source or by providing an ion gate between the source 1 and the separator 3.

1. A method of mass spectrometry comprising:
a) accumulating precursor ions in a first ion accumulator;
b) performing a separation cycle comprising pulsing a packet of the precursor ions out of the first ion accumulator and into an ion separator, and separating the precursor ions such that precursor ions having different values of a first physicochemical property elute from the ion separator at different times;
c) mass filtering the precursor ions that elute from the ion separator so as to transmit a selected precursor ion species;
d) fragmenting or reacting the selected precursor ion species so as to generate a set of fragment or product ion species therefrom;
e) accumulating the set of fragment or product ion species in a second ion accumulator;
f) releasing the set of fragment or product ion species from the second ion accumulator into a TOF mass analyser, wherein operation of the TOF mass analyser is synchronised with the release of ions from the second ion accumulator such that multiple different species of the set of fragment or product ion species are simultaneously pulsed into a time of flight region of the TOF mass analyser by a pusher electrode; and
g) repeating steps c) to f) at least once during said separation cycle, wherein said selected precursor ion species is different each time steps c) to f) are performed.

2. The method of claim 1, wherein the ion separator is an ion mobility separator and the physicochemical property is ion mobility.

3. The method of claim 1, wherein the fragment or product ion species are urged into the second ion accumulator such that:
(i) fragment or product ion species that are derived from the same precursor ion species arrive at the second ion accumulator over substantially the same time period and are accumulated in the second ion accumulator during at least part of this time period; and/or
(ii) fragment or product ion species that are derived from precursor species that are transmitted by the mass filter at different times arrive at the second ion accumulator over different respective time periods.

4. The method of claim 1, wherein each time the sequence of steps c) to e) is performed, fragment or product ion species are accumulated in the second ion accumulator over a time period that is the same as, or correlated to, the time period during which their precursor ion species is transmitted by the mass filter.

5. The method of claim 1, wherein each time the sequence of steps c) to e) is performed, only fragment or product ion species derived from the selected precursor ion species, and optionally some ions of the selected precursor ion species itself, are accumulated in the second ion accumulator; whereas other precursor ions species and fragment or product ions derived therefrom are not accumulated in the second ion accumulator.

6. The method of claim 1 wherein each time the sequence of steps b) and c) is performed, the mass filter is controlled so as to transmit the precursor ion species of interest only over a time period that is the same as, correlated to, or shorter than the time period during which that precursor ion species elutes from the ion separator.

7. The method of claim 1, wherein step f) comprises releasing the fragment or product ion species from the second ion accumulator in reverse order of mass to charge ratio, starting with ions of relatively high mass to charge ratio and progressively releasing ions of progressively lower mass to charge ratios, such that different ones of the fragment or product ion species simultaneously arrive at the pusher and are simultaneously pulsed into the time of flight region of the TOF mass analyser by the pusher electrode.

8. The method of claim 7, wherein a transfer region is provided between the second ion accumulator and the TOF mass analyser, and wherein the pressure in the transfer region and the energies with which ions are released from second ion accumulator are such that fragment or product ions having relatively low mass to charge ratios catch up with fragment or product ions having a higher mass to charge ratio so that the ions simultaneously arrive at the pusher and are simultaneously pulsed into the time of flight region of the TOF mass analyser by the pusher electrode.

9. The method of claim 7, wherein substantially all of the fragment or product ion species released from the second ion accumulator, each time step f) is performed, arrive at the pusher at substantially the same time and are simultaneously pulsed into the time of flight region of the TOF mass analyser by the pusher electrode.

10. The method of claim 1, wherein step f) comprises releasing all of the fragment or product ion species from the second ion accumulator at substantially the same time, wherein a transfer region is provided between the second ion accumulator and the TOF mass analyser, wherein ions are separated in the transfer region according to a second physicochemical property such that fragment or product ion species arrive at the TOF mass analyser at times that depend on their second physicochemical property value, and wherein the operation of the TOF mass analyser is synchronised with the release of ions from the second ion accumulator such that fragment or product ion species having a selected range of values of the second physicochemical property value are simultaneously pulsed into the time of flight region of the TOF mass analyser by the pusher electrode.

11. The method of claim 10, comprising receiving an input signal, at a mass spectrometer performing the method, that is representative of said selected range of values of the second physicochemical property, and wherein said operation of the TOF mass analyser is synchronised with the release of ions from the second ion accumulator such that fragment or product ion species having said selected range of values of the second physicochemical property value are simultaneously pulsed into the time of flight region of the TOF mass analyser by the pusher electrode.

12. The method of claim 10, wherein the second physicochemical property is mass to charge ratio, such that ions are separated in the transfer region according to mass to charge ratio wherein the second physicochemical property is ion mobility, such that ions are separated in the transfer region according to ion mobility.

13. (canceled)

14. The method of claim 1, wherein steps a) to g) are repeated during a single experimental run.

15. A mass spectrometer comprising:
a first ion accumulator;
an ion separator;
a mass filter;
a fragmentation or reaction device;
a second ion accumulator;
a TOF mass analyser having a time of flight region and a pusher electrode; and
control circuitry configured to control the mass spectrometer to:
a) accumulate precursor ions in the first ion accumulator;
b) perform a separation cycle comprising pulsing a packet of the precursor ions out of the first ion accumulator and into the ion separator, and separating the precursor ions in the ion separator such that precursor ions having different values of a first physicochemical property elute from the ion separator at different times;
c) mass filter the precursor ions that elute from the ion separator using the mass filter so as to transmit a selected precursor ion species;
d) fragment or react the selected precursor ion species in the fragmentation or reaction device so as to generate a set of fragment or product ion species therefrom;
e) accumulate the set of fragment or product ion species in the second ion accumulator;
f) release the set of fragment or product ion species from the second ion accumulator into the TOF mass analyser, wherein operation of the TOF mass analyser is synchronised with the release of ions from the second ion accumulator such that multiple different species of the set of fragment or product ion species are simultaneously pulsed into the time of flight region of the TOF mass analyser by the pusher electrode; and
g) repeat steps c) to f) at least once during said separation cycle, wherein the mass filter is controlled such that said selected precursor ion species is different each time steps c) to f) are performed.

16. The mass spectrometer of claim 15, wherein the control circuitry is configured to control the mass spectrometer such that step f) comprises releasing the fragment or product ion species from the second ion accumulator in reverse order of mass to charge ratio, starting with ions of relatively high mass to charge ratio and progressively releasing ions of progressively lower mass to charge ratios, such that different ones of the fragment or product ion species simultaneously arrive at the pusher and are simultaneously pulsed into the time of flight region of the TOF mass analyser by the pusher electrode.

17. The mass spectrometer of claim 16, comprising a transfer region between the second ion accumulator and the TOF mass analyser, wherein the spectrometer is configured to maintain the pressure in the transfer region and release ions from the second ion accumulator with energies such that fragment or product ions having relatively low mass to charge ratios catch up with fragment or product ions having a higher mass to charge ratio so that the ions simultaneously arrive at the pusher and are simultaneously pulsed into the time of flight region of the TOF mass analyser by the pusher electrode.

18. The mass spectrometer of claim 15, comprising a transfer region between the second ion accumulator and the TOF mass analyser; wherein the control circuitry is configured to control the mass spectrometer such that step f) comprises releasing all of the fragment or product ion species from the second ion accumulator into the transfer region at substantially the same time such that fragment or product ion species are separated in the transfer region according to a second physicochemical property and arrive at the TOF mass analyser at times that depend on their second physicochemical property value, and wherein the operation of the TOF mass analyser is synchronised with the release of ions from the second ion accumulator such that fragment or product ion species having a selected range of values of the second physicochemical property value are simultaneously pulsed into the time of flight region of the TOF mass analyser by the pusher electrode.

19. The mass spectrometer of claim 18, comprising a user interface configured for inputting a selected range of values of the second physicochemical property; wherein the spectrometer is configured such that the control circuitry controls the operation of the TOF mass analyser, based on the selected range of values, to synchronise the operation of the TOF mass analyser with the release of ions from the second ion accumulator such that fragment or product ion species having said selected range of values of the second physicochemical property value are simultaneously pulsed into the time of flight region of the TOF mass analyser by the pusher electrode.

20. A method of mass spectrometry comprising:
a) accumulating precursor ions in a first ion accumulator;
b) performing a separation cycle comprising pulsing a packet of the precursor ions out of the first ion accumulator and into an ion separator, and separating the precursor ions such that precursor ions having different values of a first physicochemical property elute from the ion separator at different times;
c) switching a mass filter that mass filters the precursor ions that elute from the ion separator so as to begin transmitting a selected precursor ion species;
d) fragmenting or reacting the selected precursor ion species so as to generate a set or fragment or product ion species therefrom;
e) transferring the set of fragment or product ion species through a transfer region to a TOF mass analyser having a pusher electrode and a time of flight region, wherein ions are separated in the transfer region according to a second physicochemical property such that fragment or product ion species arrive at the TOF mass analyser at times that depend on their second physicochemical property values, and wherein the operation of the TOF mass analyser is synchronised with the time that the mass filter is switched so as to begin transmitting said selected precursor ion species such that fragment or product ion species having a selected range of values of the second physicochemical property that arrive at the pusher electrode substantially simultaneously are simultaneously pulsed into the time of flight region of the TOF mass analyser by the pusher electrode; and
f) repeating steps c) to e) at least once during said separation cycle, wherein said selected precursor ion species is different each time steps c) to e) are performed.

21. (canceled)

22. A mass spectrometer comprising:
a first ion accumulator;
an ion separator;
a mass filter;
a fragmentation or reaction device;
a TOF mass analyser having a time of flight region and a pusher electrode;
a transfer region between the fragmentation or reaction device and the TOF mass analyser; and
control circuitry configured to control the mass spectrometer to perform the method of claim 20.
